(19) United States
(12) Patent Application Publication
(10) Pub. No.: US 2006/0258400 A1
(43) Pub. Date: Nov. 16, 2006

(54) Method for automatically recognizing external device in mobile communication terminal and mobile communication terminal designed for implementing the same

(75) Inventor: Hong Ki Lee, Gyeonggi-do (KR)

Correspondence Address: Jonathan Y. Kang, Esq.;LEE, HONG, DEGERMAN, KANG & SCHMADEKA, 12th Floor, 801 S. Figueroa Street, Los Angeles, CA, 90017, US

(73) Assignee: LG Electronics Inc.

(21) Appl. No.: 11/433,160

(22) Filed: May 12, 2006

(30) Foreign Application Priority Data
May 16, 2005 (KR) 10-2005-0040516

(51) Int. Cl. H04B 1/38

(52) U.S. Cl. 455/557

(57) ABSTRACT

A method and a mobile terminal for automatically recognizing the connection of an external device are provided. By measuring a first voltage between a first pole of an earphone jack and ground and measuring a second voltage between a second pole of the earphone jack and ground, a controller determines whether an external device is connected to the mobile terminal based on changes in the measured first voltage and, when an external device is connected, the controller determines the type of the external device based on the measured second voltage. Therefore, the mobile terminal automatically determines the type of the external device connected through the earphone jack and automatically switches to a TTY transmission mode when a TTY terminal or CTM converter is connected.

### CROSS-REFERENCE TO RELATED APPLICATIONS

Pursuant to 35 U.S.C. § 119(a), this application claims the benefit of earlier filing date and right of priority to Korean Application No. No. 10-2005-0040516, filed on May 16, 2005, the contents of which is hereby incorporated by reference herein in its entirety.

### BACKGROUND OF THE INVENTION

1. Field of the Invention

The present invention relates to a method for automatically recognizing an external device and a mobile communication terminal designed for implementing the same, and more particularly, to a method wherein the mobile communication terminal automatically detects whether an external device such as a TTY terminal, a CTM converter or an ear/microphone is connected to the mobile communication terminal.

2. Description of the Related Art

A mobile communication terminal that supports a teletypewriter (TTY) function is used to help deaf persons conduct telephone conversations. The TTY function allows a mobile communication terminal or a general telephone to convert characters input from a device, such as a TTY terminal, into audio signals and to transfer the audio signals to a counterpart device.

In order for the mobile communication terminal to perform the TTY function, a TTY terminal must be connected to the mobile communication terminal. Two methods, an internal method and an external method, are used to connect a TTY terminal to a mobile communication terminal.

In the internal method, an earphone plug of the TTY terminal is directly connected to an earphone jack of the mobile communication terminal. In the external method, the TTY terminal is connected to a Cellular Text Telephone Modem (CTM) converter and the CTM converter is connected to the earphone jack of the mobile communication terminal. The earphone jack has a first pole, such as a microphone input terminal “MIC”, a second pole, such as a speaker output terminal “SPK”, and a third pole, such as ground “GND”. The earphone plug is similar to the earphone plug of a general hands-free earphone/microphone, also referred to as an ear/microphone.

The earphone plug of the TTY terminal or the CTM converter has an internal resistance between its first pole (MIC) and its third pole (GND), similar to the earphone plug of the general ear/microphone. Once an earphone plug of an external device, such as a TTY terminal, a CTM converter or an ear/microphone, is connected to an earphone jack of a mobile communication terminal, a voltage at a first pole (MIC) of the earphone jack is reduced by a certain level due to the internal resistance.

By detecting a change in the voltage at the first pole (MIC) of the earphone jack, the mobile communication terminal can determine whether an external device is connected to the mobile communication terminal. However, since external devices, such as the TTY terminal, the CTM converter, and the ear/microphone, may have the same internal resistance, the voltage may be reduced by the same level when each external device is connected to the mobile communication terminal. Therefore, even when the mobile communication terminal measures the voltage drop as an external device is connected, the mobile communication terminal cannot determine whether the external device is a TTY terminal, a CTM converter, or an ear/microphone.

Since the mobile communication terminal cannot determine the type of the connected external device, the mobile communication terminal cannot determine whether to remain in a conventional communication mode or to switch to a TTY transmission mode. Therefore, when the user has connected the earphone plug of the TTY terminal or the CTM converter to the earphone jack of the mobile communication terminal in order to use the TTY function, the user must operate an input unit on the mobile communication terminal to switch the mode of the mobile communication terminal to the TTY transmission mode.

Therefore, there is a need for a method whereby a mobile communication terminal may detect the type external device that has been connected. The present invention addresses this and other needs.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The invention is directed to provide a method for automatically recognizing a type of external device that has been connected to a mobile communication terminal and a mobile communication terminal designed for implementing the same. An object of the present invention is to provide a method for automatically recognizing a type of external device that has been connected to a mobile communication terminal, wherein the mobile communication terminal can automatically determine the type of external device connected through an earphone jack. Another object of the present invention is to provide a method for automatically recognizing a type of external device that has been connected to a mobile communication terminal and a mobile communication terminal designed for implementing the same, wherein the mobile communication terminal can automatically switch to a TTY transmission mode when the external device connected to the mobile communication terminal is a TTY terminal or a CTM converter.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In one aspect of the present invention, a mobile communication terminal is provided. The mobile communication terminal includes a first detector adapted to measure a voltage between a first pole of an earphone jack and ground, a second detector adapted to measure a voltage between a second pole of the earphone jack and ground and a controller adapted to detect connection of an external device to the earphone jack and determine a type of external device connected, the connection of the external device detected according to a change in the voltage measured by the first detector and the type of external device determined according to a change in the voltage measured by the second detector.

It is contemplated that the first pole of the earphone jack is a microphone input terminal and the second pole of the earphone jack is a speaker output terminal. It is further contemplated that the controller is further adapted to detect connection of an external device when the change in the voltage measured by the first detector is a decrease.

It is contemplated that the controller is further adapted to detect connection of an external device when the change in the voltage measured by the first detector is a decrease by a factor of at least approximately 100. It is further contemplated that the controller is further adapted to detect removal of a previously connected external device when the change in the voltage measured by the first detector is an increase.

It is contemplated that the mobile communication terminal supports a teletypewriter (TTY) function and the controller is further adapted to determine the type of external device as either an ear/microphone or a TTY terminal/cellular text telephone modem (CTM) converter by calculating a resistance of the external device based on the change in the voltage measured by the second detector. It is further contemplated that the controller is further adapted to switch the mobile communication terminal to a TTY transmission mode when the determined type of the external device is a TTY terminal/CTM converter.

It is contemplated that the controller is further adapted to determine the type of the external device as an ear/microphone when the resistance of the external device is within a predetermined range and to determine the type of the external device as a TTY terminal/CTM converter when the resistance of the external device is outside the predetermined range. It is further contemplated that the predetermined range is 28Ω to 35Ω.

It is contemplated that the mobile communication terminal further includes a first voltage source and a first internal resistor connected to the first pole of the earphone jack, a first Analog to Digital (A/D) converter adapted to measure the voltage between the first pole of the earphone jack and ground, a second voltage source and a second internal resistor connected to the second pole of the earphone jack, a second A/D converter adapted to measure the voltage between the second pole of the earphone jack and ground and a switch adapted to close according to a control signal from the controller, the switch connected between the second pole of the earphone jack and the second A/D converter. It is further contemplated that the controller is further adapted to generate the control signal when connection of an external device is detected.

It is contemplated that the controller is adapted to detect connection of an external device when there is a decrease in the voltage measured by the first A/D converter. It is further contemplated that the controller is further adapted to detect connection of an external device when there is a decrease in the voltage measured by the first A/D converter by a factor of at least approximately

It is contemplated that the controller is further adapted to detect removal of a previously connected external device when there is an increase in the voltage measured by the first A/D converter. It is further contemplated that the mobile communication terminal supports a teletypewriter (TTY) function and the controller is further adapted to determine the type of external device as either an ear/microphone or a TTY terminal/cellular text telephone modem (CTM) converter by calculating a resistance of the external device based on a change in the voltage measured by the second A/D converter.

It is contemplated that the controller is further adapted to switch the mobile communication terminal to a TTY transmission mode when the controller determines the type of the external device as a TTY terminal/CTM converter. It is further contemplated that the controller is further adapted to determine the type of the external device as an ear/microphone when the resistance of the external device is within a predetermined range and to determine the type of the external device as a TTY terminal/CTM converter when the resistance of the external device is outside the predetermined range. Preferably, the predetermined range is 28Ω to 35Ω.

In another aspect of the present invention, a method for automatically detecting the connection of an external device to a mobile communication terminal is provided. The method includes measuring a voltage between a first pole of an earphone jack and ground, measuring a voltage between a second pole of the earphone jack and ground, detecting connection of the external device to the earphone jack according to the voltage between the first pole of the earphone jack and ground and determining a type of the external device according to the voltage between the second pole of the earphone jack and ground.

It is contemplated that detecting connection of the external device includes determining that the voltage between the first pole of the earphone jack and ground has decreased. It is further contemplated that detecting connection of the external device includes determining that the voltage between the first pole of the earphone jack and ground has decreased by a factor of at least approximately 100.

It is contemplated that the method includes detecting removal of a previously connected external device when the voltage between the first pole of the earphone jack and ground increases. It is further contemplated that determining the type of the external device includes determining that the external device is either an ear/microphone or a TTY terminal/cellular text telephone modem (CTM) converter by calculating a resistance of the external device based on a change in the voltage between the second pole of the earphone jack and ground.

It is contemplated that the method includes switching the mobile communication terminal to a TTY transmission mode when the external device is determined as a TTY terminal/CTM converter. It is further contemplated that the method further includes determining the external device as an ear/microphone when the resistance of the external device is within a predetermined range and determining the external device as a TTY terminal/CTM converter when the resistance of the external device is outside the predetermined range. Preferably, the predetermined range is 28Ω to 35Ω.

It is to be understood that both the foregoing general description and the following detailed description of the present invention are exemplary and explanatory and are intended to provide further explanation of the invention as claimed. Additional features and advantages of the invention will be set forth in the description which follows, and in part will be apparent from the description, or may be learned by practice of the invention. These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIGS. 1A and 1B illustrate connection between a mobile communication terminal according to the present invention and an external device such as a TTY terminal or a CTM converter.

FIG. 2 is a simple internal circuit diagram illustrating the condition when no external device is connected to the mobile communication terminal according to the present invention.

FIG. 3 is another internal circuit diagram illustrating the condition when no external device is connected to the mobile communication terminal according to the present invention.

FIG. 4 is a simple internal circuit diagram illustrating the condition when an external device is connected to the mobile communication terminal according to the present invention.

FIG. 5 is another internal circuit diagram illustrating the condition when an external device is connected to the mobile communication terminal according to the present invention.

FIG. 6 is a flow chart illustrating a method for automatically recognizing a type of external device connected to a mobile communication terminal according to the present invention.

### DETAILED DESCRIPTION OF THE PREFERRED EMBODIMENTS

The present invention relates to an apparatus and method for enabling a mobile communication terminal to detect the type of external device to which it has been connected. As used herein, the term “mobile communication terminal” should be construed as including not only cellular and PCS phones but also fixed-line telephones, PDAs, notebook and laptop computers, and desktop computers.

Reference will now be made in detail to the preferred embodiments of the present invention, examples of which are illustrated in the accompanying drawings. It should be understood that the terms used in the specification and appended claims should not be construed as limited to general and dictionary meanings but be construed based on the meanings and concepts according to the spirit of the present invention on the basis of the principle that the inventor is permitted define appropriate terms for the best explanation. The preferred embodiments described in the specification and shown in the drawings are illustrative only and are not intended to represent all aspects of the invention, such that various equivalents and modifications can be made without departing from the spirit of the invention.

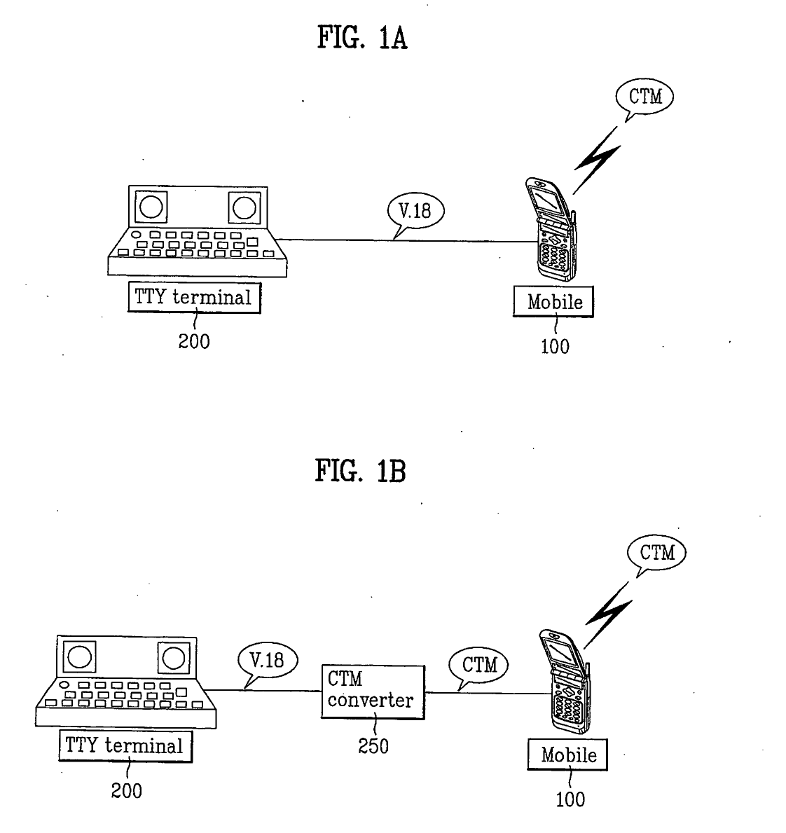

FIGS. 1A and 1B illustrate a connection between a mobile communication terminal according to the present invention and an external device, such as a TTY terminal or a CTM converter. As illustrated in FIG. 1A, a TTY terminal 200 is directly connected to a mobile communication terminal 100. Specifically, an earphone plug of the TTY terminal 200 may be connected to an earphone jack of the mobile communication terminal 100. The earphone plug of the TTY terminal 200 may be the same as that of a general ear/microphone. A method by which a TTY terminal 200 is directly connected to a mobile communication terminal 100 is referred to as an internal method.

The TTY terminal 200 is a teletypewriter terminal that transfers input characters to the mobile communication terminal 100. The mobile communication terminal 100, which supports a TTY function, converts signals received from the TTY terminal into audio signals and transmits the audio signals to a recipient's terminal over a mobile communication network.

Characters input to the TTY terminal 200 are converted into V.18 Baudot protocol signals and are then transmitted to the mobile communication terminal 100. Baudot is a code system in which alphabetic characters and numeric characters are represented in binary, with each character composed of 5 bits.

As illustrated in FIG. 1B, a TTY terminal 200 is connected to a CTM converter 250, with the CTM converter 250 connected to a mobile communication terminal 100. Specifically, the TTY terminal 200 is connected to the CTM converter 250 through a dedicated cable and an earphone plug of the CTM converter 250 is connected to an earphone jack of the mobile communication terminal 100. A method by which a TTY terminal 200 is connected to a mobile communication terminal 100 through the CTM converter 250 is referred to as an external method.

The CTM converter 250 converts signals input from the TTY terminal 200 into CTM signals and transmits the CTM signals to the mobile communication terminal 100. When the earphone plug of the TTY terminal, in the internal method, or the CTM converter, in the external method, is connected to the earphone jack of the mobile communication terminal 100, the mobile communication terminal 100 automatically detects that a TTY terminal or the CTM converter, hereinafter also referred to as a “TTY terminal/CTM converter,” is connected. The mobile communication terminal 100, then switches to TTY transmission mode in order to use the TTY function.

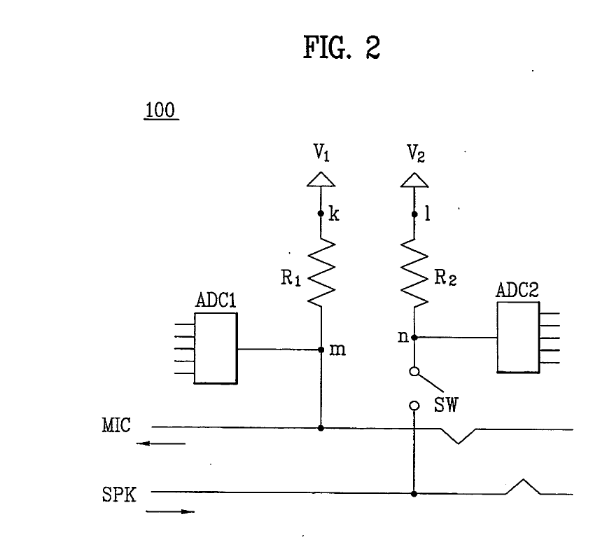

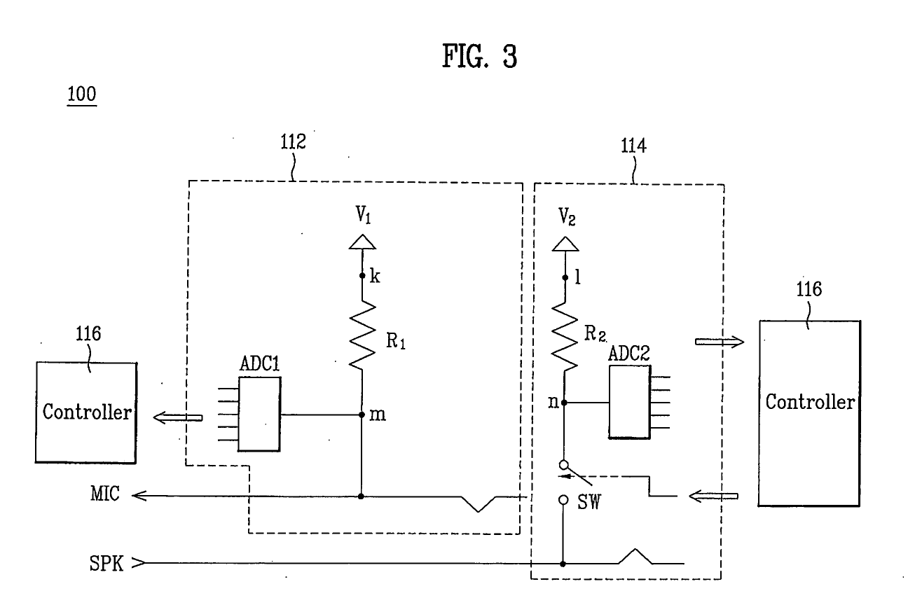

FIGS. 2 and 3 illustrate the internal circuitry of the mobile communication terminal 100 when an earphone plug of an external device, such as an earphone plug of a TTY terminal 200 or CTM converter 250, is not connected to the earphone jack of the mobile communication terminal 100. As illustrated in FIGS. 2 and 3, the mobile communication terminal 100 includes a first detector 112, a second detector 114 and a controller 116.

An earphone jack of the mobile communication terminal 100 has a first pole (MIC), a second pole (SPK), and a third pole (GND). The first pole may be a microphone input terminal (MIC) and the second pole may be a speaker output terminal (SPK).

The first detector 112 includes the first pole (MIC) of the earphone jack, a first voltage source V1, a first internal resistor R1 and a first Analog to Digital (A/D) converter ADC1. The first internal resistor R1 is connected to the first voltage source V1 and the first pole (MIC) of the earphone jack to supply a voltage to the first pole. The first A/D converter ADC1 measures a voltage between the first pole of the earphone jack and ground.

For example, when no external device is connected to the mobile communication terminal 100, as illustrated in FIGS. 2 and 3, a voltage Vm between the first pole of the earphone jack and ground, or the voltage at a node “m” in FIGS. 2 and 3, is V1. An external voltage supplied to the first detector 112, or the voltage at a node “k” in FIGS. 2 and 3, is also V1. The voltage between the first pole of the earphone jack and ground is equal to the external supply voltage V1 since no voltage drop occurs at the first internal pull up resistor R1.

Specifically, when the maximum measurable value of the first A/D converter ADC1 is lower than the external supply voltage V1, the voltage measured by the first A/D converter ADC1 is lower than the voltage V1 rather than equal to the voltage V1. For example, when the maximum measurable value of the first A/D converter ADC1 is 1.7V and the external supply voltage V1 is 2-3V, the voltage Vm measured by the first A/D converter ADC1 is the maximum measurable value “1.7V”, which is lower than the external supply voltage V1.

The second detector 114 includes the second pole (SPK) of the earphone jack, a second voltage source V2, a second internal resistor R2, a second A/D converter ADC2 and a switch SW. The second internal resistor R2 is connected to the second voltage source V2 and the second pole of the earphone jack to supply a voltage to the second pole. The second A/D converter ADC2 is connected to a contact between the second pole (SPK) of the earphone jack and the second internal resistor R2 to measure a voltage between the second pole of the earphone jack and ground.

For example, when no external device is connected to the mobile communication terminal 100, as illustrated in FIGS. 2 and 3, a voltage Vn between the second pole (SPK) of the earphone jack and ground, or the voltage at a node “n” in FIGS. 2 and 3, is V2. An external voltage supplied to the second detector 114, or the voltage at a node “I” in FIGS. 2 and 3, is also V2. The voltage between the second pole of the earphone jack and ground is equal to the external supply voltage V2 since no voltage drop occurs at the second internal pull up resistor R2.

The switch SW is connected in series between the second pole (SPK) of the earphone jack and the second A/D converter ADC2 and is opened or closed according to a control signal transmitted from the controller 116. When no external device is connected to the mobile communication terminal 100, the controller 116 provides no turn-on signal to the switch SW and, therefore, the switch SW is left open as illustrated in FIGS. 2 and 3.

The controller 116 determines whether an external device is connected to the mobile communication terminal 100 based on a change in the voltage measured by the first detector 112. When the controller 116 determines that an external device is connected, the controller 116 provides a control signal to the second detector 114 and determines the type of external device by calculating a resistance of the external device based on a voltage measured by the second detector 114.

The type of the external device may be an ear/microphone or a TTY terminal/CTM converter. When the type of the connected external device is an ear/microphone, the mobile communication terminal 100 may be kept in the conventional communication mode. When the type of the connected external device is a TTY terminal/CTM converter, the mobile communication terminal 100 must be switched from a conventional communication mode to a TTY transmission mode. Accordingly, the controller 116 switches the operating mode of the mobile communication terminal 100 to the TTY transmission mode when it is determined that the type of the external device is a TTY terminal/CTM converter based on the voltage measured by the second detector 114.

Specifically, if the change in the voltage measured by the first detector 112 is a reduction, the controller 116 determines that an external device is connected to the mobile communication terminal 100 and further-determines the type of the external device based on the voltage measured by the second detector 114. Preferably, when the voltage change is a reduction, the reduction is about 100 times, or a factor of about 100, and when the voltage change is an increase, the increase is about 100 times, or a factor of about 100.

Specifically, the controller 116 determines that the type of the external device is an ear/microphone when the resistance of the external device is within a predetermined range and the controller 116 determines that the type of the external device is a TTY terminal/CTM converter when the resistance of the external device is outside the predetermined range. Preferably, the predetermined range is 28-35Ω such that the controller 116 determines that the type of the external device is an ear/microphone when the resistance of the external device is in the range of 28-35Ω and the controller 116 determines that type of the external device is a TTY terminal/CTM converter when the resistance of the external device is in a range of hundreds to thousands of ohms.

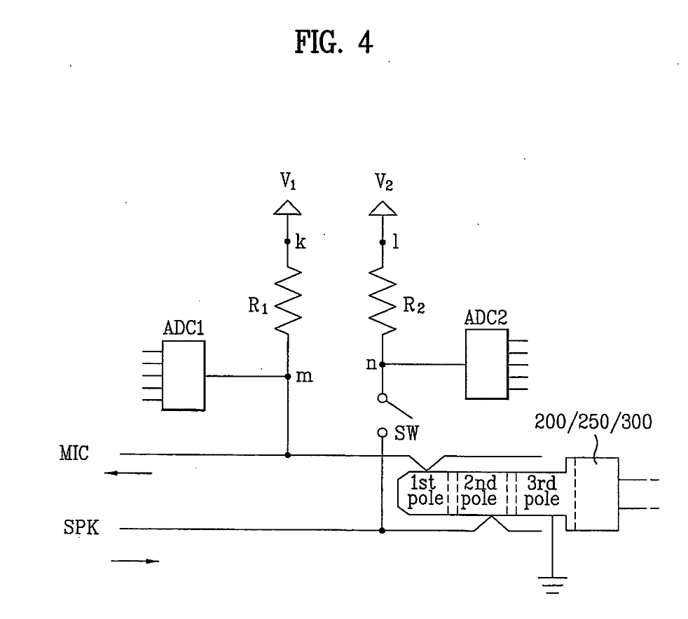

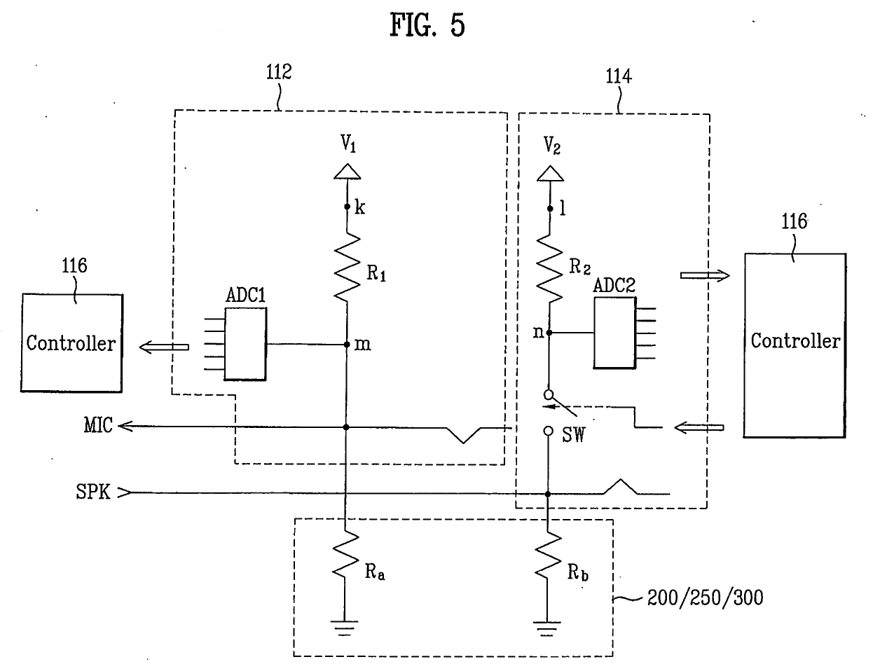

A detailed description of how the controller 116 determines the type of the external device based on the voltage measured by the second detector 114 will be described with reference to FIGS. 4 and 5. FIGS. 4 and 5 illustrate the internal circuitry of the mobile communication terminal 100 when an external device is connected to the mobile communication terminal.

As illustrated in FIGS. 4 and 5, an earphone plug of an external device, such as a TTY terminal 200, a CTM converter 250 or an ear/microphone 300, is connected to the mobile communication terminal 100. As previously described, the mobile communication terminal 100 includes a first detector 112, a second detector 114 and a controller 116.

The external device, such as the TTY terminal 200, CTM converter 250 or the ear/microphone 300, includes first, second, and third poles corresponding, respectively, to three poles (MIC, SPK, GND) of an earphone jack of the mobile communication terminal 100. The external device further includes a first resistor Ra connected to its first pole, which is connected to the first pole (MIC) of the mobile communication terminal 100, and a second resistor Rb connected to its second pole, which is connected to the second pole (SPK) of the mobile communication terminal 100.

As illustrated in FIGS. 4 and 5, when the external device 200, 250 or 300 is connected to the earphone jack of the mobile communication terminal 100, the first resistor Ra of the external device is connected to the first pole (MIC) of the mobile communication terminal 100. Therefore, an external voltage V1 supplied to the first detector 112 is reduced according to the equation “V1*R1/(R1+Ra)” at the first resistor Ra, such that a voltage Vm between the first pole (MIC) of the earphone jack and ground, or the voltage at node “m” in FIGS. 4 and 5, is represented by the equation “V1*Ra/(R1+Ra)”.

Since the voltage Vm is V1 when no external device is connected, as described previously with reference to FIGS. 2 and 3, and the voltage Vm is “V1*Ra/(R1+Ra)” after the external device is connected, the connection of the external device reduces the voltage Vm approximately “(R1+Ra)/Ra” times, or by a factor of about “(R1+Ra)/Ra)”. For example, when the first internal resistor R1 of the mobile communication terminal 100 is tens of thousands of ohms and the first resistor Ra of the external device 200, 250 or 300 is 2 kΩ, factor “Ra/(R1+Ra)” is about 0.01-0.09.

Therefore, connecting the external device 200, 250 or 300 reduces the voltage Vm between the first pole (MIC) of the earphone jack and ground by about 10-100 times, or 1/0.09-1/0.01 times. Practically, when the maximum measurable value of the first A/D converter ADC1 is lower than the external supply voltage V1, the voltage Vm between the first pole (MIC) of the earphone jack and ground is reduced by less than the factor “(R1+Ra)/Ra”.

Taking into consideration that the voltage Vm between the first pole (MIC) of the earphone jack and ground is reduced when the external device 200, 250 or 300 is connected, the controller 116 may determine that an external device is connected when the voltage Vm between the first pole (MIC) of the earphone jack and ground is reduced while determining that a previously connected external device is removed when the voltage Vm between the first pole of the earphone jack and ground increases. While the controller 116 can determine whether an external device is connected based on the change in the voltage Vm between the first pole (MIC) of the earphone jack and ground, the controller 116 cannot determine the type of the external device based on the change in the voltage Vm, for example, whether the external device is an ear/microphone 300, a TTY terminal 200 or a CTM converter 250.

Once the controller 116 determines that an external device 200, 250 or 300 is connected based on the change in the voltage Vm measured by the first detector 112, the controller determines the type of external device 200, 250 or 300 based on a voltage Vn measured by the second detector 114. The following is a description of the principle of determination of the type of the external device 200, 250 or 300 based on the voltage Vn.

After the controller 116 determines, based on the voltage Vm, that an external device 200, 250 or 300 is connected, the controller 116 transfers a control signal to the second detector 114, specifically to close a switch SW in the second detector 114. Since the second resistor Rb of the external device 200, 250 or 300 is connected to the second pole (SPK) of the mobile communication terminal 100, an external voltage V2 supplied to the second detector 114 is reduced according to the equation “V2*R2/(R2+Rb)” at the second resistor Rb. Therefore, a voltage Vn between the second pole (SPK) of the earphone jack and ground, or the voltage at a node “n” in FIGS. 4 and 5, shifts from V2 to “V2*Rb/(R2+Rb)”.

After detecting the voltage Vn at the second pole (SPK) when the external device 200, 250 or 300 is connected, the controller 116 calculates the resistance of second resistor Rb of the external device by substituting the measured voltage Vn, the known voltage V2 and the known second internal resistance R2 into the equation “Vn=V2*Rb/(R2+Rb)”, or in other words, “Rb=R2*Vn/(V2−Vn)”. For example, when Vn is 0.06V, V2 is 2.00V, and R2 is 1 kΩ, Rb is 30.9Ω according to the calculation “Rb=R2*Vn/(V2−Vn)=1 kΩ*0.06V/(2.00−0.06V)=30.9Ω”.

After calculating the resistance of the second resistor Rb using the measured voltage Vn between the second pole (SPK) and ground, the controller 116 determines the type of the external device 200, 250 or 300 according to the calculated resistance Rb of the second resistor Rb of the external device. For example, when the resistance Rb of the second resistor Rb is 30.9Ω, the controller 116 determines that the external device is an ear/microphone 300 since the resistance of the second resistor Rb is within the range of 28-35Ω. When the resistance Rb of the second resistor Rb is 1000Ω, the controller 116 determines that the external device is a TTY terminal 200 or CTM converter 250 and switches the mobile communication terminal 100 to the TTY transmission mode.

The reason why the type of the external device can be determined as an ear/microphone 300 when the resistance of the external device is within the range of 28-35Ω is that the standard resistance of the second resistor Rb, or the standard speaker resistance of the ear/microphone 300, is 32Ω. Further, the reason why the type of the external device can be determined as an TTY terminal 200 or CTM converter 250 when the resistance of the external device is 1000Ω is that the resistance of the second resistor Rb of a TTY terminal or CTM converter varies depending on the manufacturer, but is approximately hundreds to thousands of ohms.

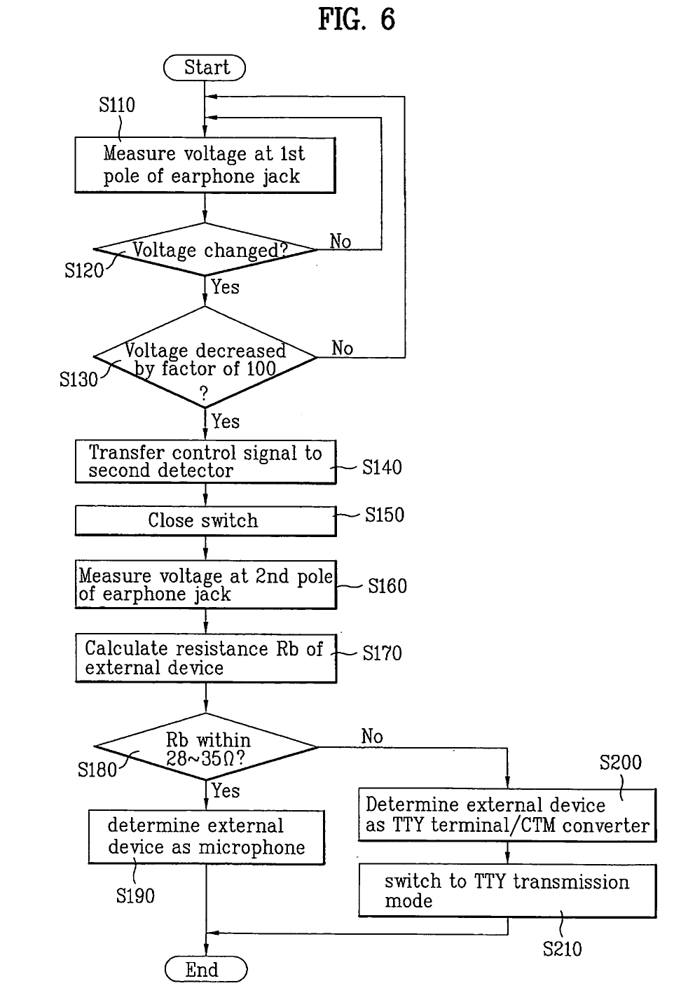

FIG. 6 illustrates a flow chart of a method for automatically recognizing an external device in a mobile communication terminal according to the present invention. As illustrated in FIG. 6, the first detector 112 of the mobile communication terminal 100 first measures a voltage Vm between the first pole (MIC) of the earphone jack and ground (S110). The controller 116 then determines whether the voltage Vm measured at step S110 has changed (S120). If the voltage Vm has changed, the controller 116 determines whether the voltage Vm is reduced by a predetermined level, for example, by a factor of 100 (S130).

When the voltage Vm is reduced by the predetermined level, the controller 116 determines that an external device 200, 250 or 300 is connected and transfers a control signal to the second detector 114. The second detector 114 receives the control signal from the controller 116 (S140).

When the voltage Vm is not reduced by the predetermined level or is increased, the controller 116 determines that no external device 200, 250 or 300 is connected. The controller continues to measure the voltage Vm until a reduction by the predetermined level is detected.

The control signal causes the switch of the second detector 114 to close (S150). The second detector 114 then measures a voltage Vn between the second pole of the earphone jack and ground (S160).

The controller 116 calculates a resistance of the second resistor Rb of the external device 200, 250 or 300 based on the measured voltage Vn (S170). The controller 116 uses the equation “Rb=R2*Vn/(V2−Vn)” to calculate the resistance of the second resistor Rb.

The controller 116 determines the type of external device based on the calculated resistance of the second resistor Rb (S180). Specifically, when the calculated resistance of the second resistor Rb of the external device 200, 250 or 300 is within the range of 28-35Ω, the controller 116 determines the external device as an ear/microphone 300 (S190). When the calculated resistance of the second resistor Rb of the external device 200, 250 or 300 is outside the range of 28-35Ω, the controller 116 determines the external device as a TTY terminal 200 or CTM converter 250 (S200). If the external device is determined as a TTY terminal 200 or CTM converter 250, the controller 116 switches the mode of the mobile communication terminal 100 to the TTY transmission mode (S210).

The method for automatically recognizing an external device in a mobile communication terminal according to the present invention and a mobile communication terminal designed for implementing the same have advantages. First, when the user connects a TTY terminal or a CTM converter to an earphone jack of a mobile communication terminal in order to use a TTY function, the mobile communication terminal automatically switches to TTY transmission mode, thereby precluding the necessity for the user to operate an input unit in order to switch to the TTY transmission mode. Second, the user can immediately and easily use the TTY function since the mobile communication terminal automatically switches to the TTY transmission mode upon connecting the TTY terminal or the CTM converter to the mobile communication terminal.

It will be apparent to those skilled in the art that various modifications and variations can be made in the present invention without departing from the spirit or scope of the inventions. Therefore, it is intended that the present invention covers the modifications and variations of this invention provided they come within the scope of the appended claims and their equivalents.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A mobile communication terminal, comprising:
a first detector adapted to measure a voltage between a first pole of an earphone jack and ground;
a second detector adapted to measure a voltage between a second pole of the earphone jack and ground; and
a controller adapted to detect connection of an external device to the earphone jack and determine a type of external device connected, the connection of the external device detected according to a change in the voltage measured by the first detector and the type of external device determined according to a change in the voltage measured by the second detector.

2. The mobile communication terminal according to claim 1, wherein the first pole of the earphone jack is a microphone input terminal and the second pole of the earphone jack is a speaker output terminal.

3. The mobile communication terminal according to claim 1, wherein the controller is further adapted to detect connection of an external device when the change in the voltage measured by the first detector is a decrease.

4. The mobile communication terminal according to claim 3, wherein the controller is further adapted to detect connection of an external device when the change in the voltage measured by the first detector is a decrease by a factor of at least approximately 100.

5. The mobile communication terminal according to claim 3, wherein the controller is further adapted to detect removal of a previously connected external device when the change in the voltage measured by the first detector is an increase.

6. The mobile communication terminal according to claim 1, wherein the mobile communication terminal supports a teletypewriter (TTY) function and the controller is further adapted to determine the type of external device as one of an ear/microphone and a TTY terminal/cellular text telephone modem (CTM) converter by calculating a resistance of the external device based on the change in the voltage measured by the second detector.

7. The mobile communication terminal according to claim 6, wherein the controller is further adapted to switch the mobile communication terminal to a TTY transmission mode when the determined type of the external device is a TTY terminal/CTM converter.

8. The mobile communication terminal according to claim 6, wherein the controller is further adapted to determine the type of the external device as an ear/microphone when the resistance of the external device is within a predetermined range and to determine the type of the external device as a TTY terminal/CTM converter when the resistance of the external device is outside the predetermined range.

9. The mobile communication terminal according to claim 8, wherein the predetermined range is 28Ω to 35Ω.

10. The mobile communication terminal according to claim 1, further comprising:
a first voltage source and a first internal resistor connected to the first pole of the earphone jack;
a first Analog to Digital (A/D) converter adapted to measure the voltage between the first pole of the earphone jack and ground;
a second voltage source and a second internal resistor connected to the second pole of the earphone jack;
a second A/D converter adapted to measure the voltage between the second pole of the earphone jack and ground; and
a switch adapted to close according to a control signal from the controller, the switch connected between the second pole of the earphone jack and the second A/D converter.

11. The mobile communication terminal according to claim 10, wherein the controller is further adapted to generate the control signal when connection of an external device is detected.

12. The mobile communication terminal according to claim 10, wherein the controller is adapted to detect connection of an external device when there is a decrease in the voltage measured by the first A/D converter.

13. The mobile communication terminal according to claim 12, wherein the controller is further adapted to detect connection of an external device when there is a decrease in the voltage measured by the first A/D converter by a factor of at least approximately 100.

14. The mobile communication terminal according to claim 12, wherein the controller is further adapted to detect removal of a previously connected external device when there is an increase in the voltage measured by the first A/D converter.

15. The mobile communication terminal according to claim 10, wherein the mobile communication terminal supports a teletypewriter (TTY) function and the controller is further adapted to determine the type of external device as one of an ear/microphone and a TTY terminal/cellular text telephone modem (CTM) converter by calculating a resistance of the external device based on a change in the voltage measured by the second A/D converter.

16. The mobile communication terminal according to claim 15, wherein the controller is further adapted to switch the mobile communication terminal to a TTY transmission mode when the controller determines the type of the external device as a TTY terminal/CTM converter.

17. The mobile communication terminal according to claim 15, wherein the controller is further adapted to determine the type of the external device as an ear/microphone when the resistance of the external device is within a predetermined range and to determine the type of the external device as a TTY terminal/CTM converter when the resistance of the external device is outside the predetermined range.

18. The mobile communication terminal according to claim 17, wherein the predetermined range is 28Ω to 35Ω.

19. A method for automatically detecting the connection of an external device to a mobile communication terminal, the method comprising:
measuring a voltage between a first pole of an earphone jack and ground;
measuring a voltage between a second pole of the earphone jack and ground;
detecting connection of the external device to the earphone jack according to the voltage between the first pole of the earphone jack and ground; and
determining a type of the external device according to the voltage between the second pole of the earphone jack and ground.

20. The method according to claim 20, wherein detecting connection of the external device comprises determining that the voltage between the first pole of the earphone jack and ground has decreased.

21. The method according to claim 20, wherein detecting connection of the external device comprises determining that the voltage between the first pole of the earphone jack and ground has decreased by a factor of at least approximately 100.

22. The method according to claim 20, further comprising detecting removal of a previously connected external device when the voltage between the first pole of the earphone jack and ground increases.

23. The method according to claim 20, wherein determining the type of the external device comprises determining that the external device is one of an ear/microphone and a TTY terminal/cellular text telephone modem (CTM) converter by calculating a resistance of the external device based on a change in the voltage between the second pole of the earphone jack and ground.

24. The method according to claim 23, further comprising switching the mobile communication terminal to a TTY transmission mode when the external device is determined as a TTY terminal/CTM converter.

25. The method according to claim 23, further comprising determining the external device as an ear/microphone when the resistance of the external device is within a predetermined range and determining the external device as a TTY terminal/CTM converter when the resistance of the external device is outside the predetermined range.

26. The method according to claim 25, wherein the predetermined range is 28Ω to 35Ω.
